(19) United States
(12) Patent Application Publication
(10) Pub. No.: US 2011/0273396 A1
(43) Pub. Date: Nov. 10, 2011

(54) TOUCH SCREEN DEVICE

(75) Inventor: Il Kwon CHUNG, Gyunggi-do (KR)

(73) Assignee: SAMSUNG ELECTRO-MECHANICS CO., LTD., Gyunggi-do (KR)

(21) Appl. No.: 12/843,769

(22) Filed: Jul. 26, 2010

(30) Foreign Application Priority Data
May 6, 2010 (KR) 10-2010-0042550

(51) Int. Cl. G06F 3/045

(52) U.S. Cl. 345/174

(57) ABSTRACT

Disclosed herein is a touch screen device, including: a touch panel; a display panel that is installed under the touch panel; and a plurality of pressure-sensitive sensors that are formed to be spaced from each other on the outer sides between the touch panel and the display panel and include an insulating substrate, electrodes that include anode electrodes and cathode electrodes formed to be spaced from each other on the insulating substrate, and piezo resistors that are formed on the insulating substrate on which the electrodes are formed and have resistance values varied depending on the pressure to be applied. The touch screen device can measure the strength of the contact input as well as the 2D coordinates using the piezo resistors of the pressure-sensitive sensor.

### CROSS REFERENCE TO RELATED APPLICATION

This application claims the benefit of Korean Patent Application No. 10-2010-0042550, filed on May 6, 2010, entitled “Touch Screen Device”, which is hereby incorporated by reference in its entirety into this application.

### BACKGROUND OF THE INVENTION

1. Technical Field

The present invention relates to a touch screen device.

2. Description of the Related Art

With the continuous development in the electronic technology and the information technology fields, the relative importance of electronic devices is constantly increasing in everyday life, including work environment. In particular, as electronic technology continuously develops, personal computers and portable transmitters, etc. process texts and graphics, using a variety of input devices, such as a keyboard, a mouse, and a digitizer. These input devices, however, have been developed in consideration of the expanding usage of personal computers, such that they are difficult to be applied to portable devices that are recently reduced in size and thickness. Therefore, touch screens are on the rise as an input device appropriated for the portable devices.

Touch screens, devices generally installed in display devices to detect positions on the screen touched by a user and control electronic devices, using information on the detected contact position as input information, in addition to controlling the picture of the display, have various advantages of being simply operated with little malfunction in a small space and very compatible with IT devices.

Meanwhile, the touch screen is classifiable as a resistive type, a capacitive type, an electromagnetic type, a surface acoustic wave (SAW) type, an infrared type, and so on. Among others, resistive and capacitive types are prevalently used in consideration of the functions and economic.

FIG. 1 is a cross-sectional view of a resistive touch screen 10 according to the prior art. Hereinafter, the resistive touch screen 10 according to the prior art will be described with reference to FIG. 1.

As shown in FIG. 1, the resistive touch screen 10 according to the prior art includes two sheets of transparent substrates 11, indium tin oxide (ITO) electrodes 14, electrode wirings 17, an adhesive layer 18, and dot spacers 19.

Herein, the respective transparent substrates 11 are provided with the ITO electrodes 14, which are connected to the electrode wirings 17 to be applied with voltage. Further, the outer sides between the transparent substrates 11 are bonded by the adhesive layer 18 and the dot spacers 19 are formed on the inner lower ITO electrodes 16 between the transparent substrates 11.

Meanwhile, when a user applies pressure to the upper transparent substrate 12 so as to perform an input, the upper transparent substrate 12 and the upper ITO substrate 15 are bent to face the lower transparent substrate 13, wherein the resistance varies while the upper ITO electrode 15 contacts the lower ITO electrode 16 are sensed to search coordinates of the input positions. At this time, the upper transparent substrate 12 may be formed of a bendable plastic film or the like.

However, the resistive touch screen 10 according to the prior art can measure only X-axis coordinates and Y-axis coordinates of the points where the upper ITO electrode 15 contacts the lower ITO electrode 16, that is, 2D coordinates, but cannot measure pressure or strength of contact input applied by a user's body or the like. Accordingly, a problem arises in that various interfaces varied depending on the strength of the contact input cannot be implemented.

### SUMMARY OF THE INVENTION

The present invention has been made in an effort to provide a touch screen device that can measure not only X-axis coordinates and Y-axis coordinates of a contact input but also the strength of the contact input, that is, Z-axis coordinates.

A touch screen device according to a preferred embodiment of the present invention includes: a touch panel; a display panel that is installed under the touch panel; and a plurality of pressure-sensitive sensors that are formed to be spaced from each other on the outer sides between the touch panel and the display panel and include an insulating substrate, electrodes that include anode electrodes and cathode electrodes formed to be spaced from each other on the insulating substrate, and piezo resistors that are formed on the insulating substrate on which the electrodes are formed and have resistance values varied depending on the pressure to be applied.

Herein, the pressure-sensitive sensor further includes an insulating layer formed on the piezo resistor.

Further, the piezo resistor has a resistance value that is decreased when pressure is applied.

Further, the resistance value of the piezo resistor is decreased when the pressure is applied to the pressure-sensitive sensor so that the anode electrode is conducted with the cathode electrode through the piezo resistor.

Further, the pressure-sensitive sensor is formed at four sides, four apexes, or them of the outer sides between the touch panel and the display panel.

Further, the piezo resistor includes a quantum tunneling composite (QTC).

Further, the touch panel is a resistive type or a capacitive type.

### BRIEF DESCRIPTION OF THE DRAWINGS

FIG. 1 is a cross-sectional view of a resistive touch screen according to the prior art;

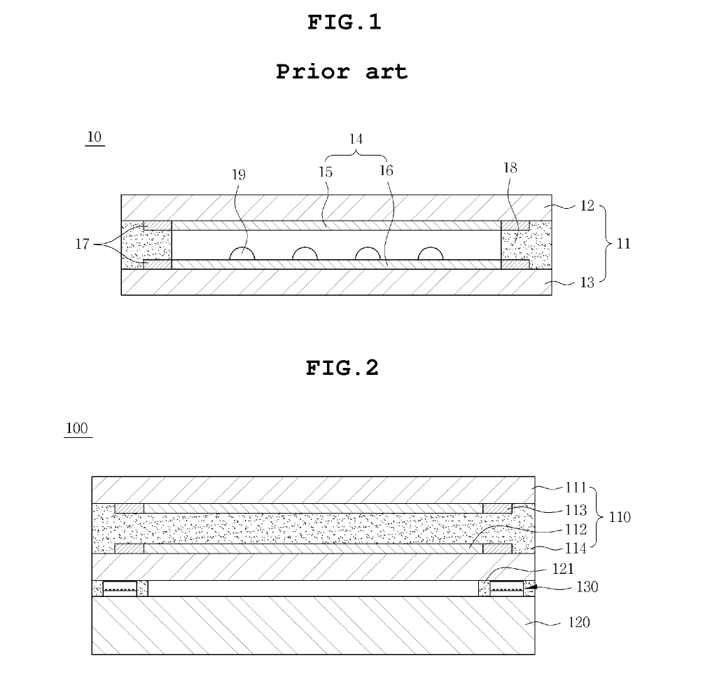

FIG. 2 is a cross-sectional view of a touch screen device according to a preferred embodiment of the present invention;

FIG. 3 is an exploded perspective view of the touch screen device of FIG. 2;

FIG. 4 is a cross-sectional view of a pressure-sensitive sensor formed on the touch screen device of FIG. 2;

FIGS. 5 and 6 are exploded perspective views of the pressure-sensitive sensor of FIG. 4;

FIG. 7 is a graph showing change in resistance values depending on pressure applied to a quantum tunneling composite (QTC) that can be used as a piezo resistor of the pressure-sensitive sensor of FIG. 4; and

FIGS. 8 and 9 are diagrams showing an operational method of the pressure-sensitive sensor of FIG. 4.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

In the specification, in adding reference numerals to components throughout the drawings, it is to be noted that like reference numerals designate like components even though components are shown in different drawings. Further, terms used in the specification, ‘first’, ‘second’, etc. can be used to describe various components, but the components are not to be construed as being limited to the terms. The terms are only used to differentiate one component from other components. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

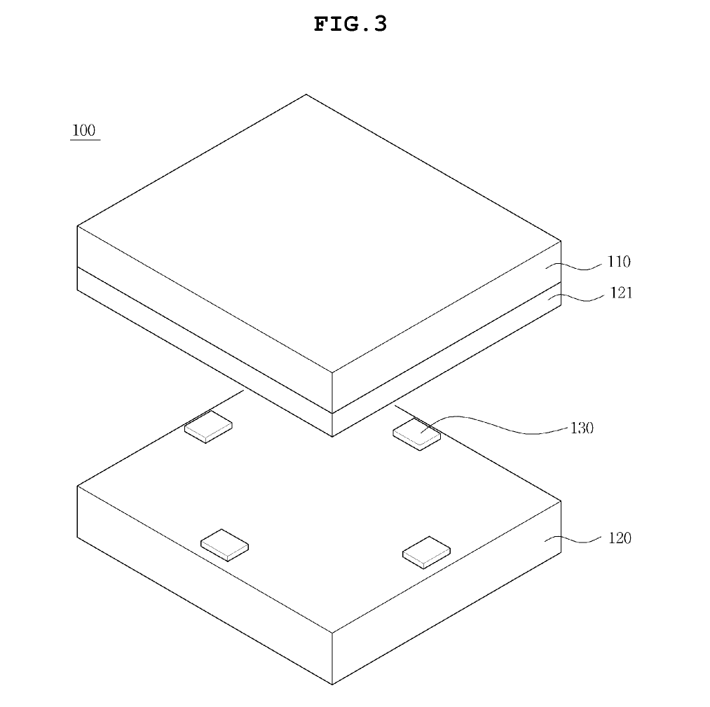

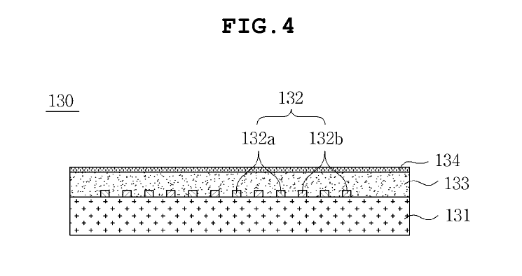

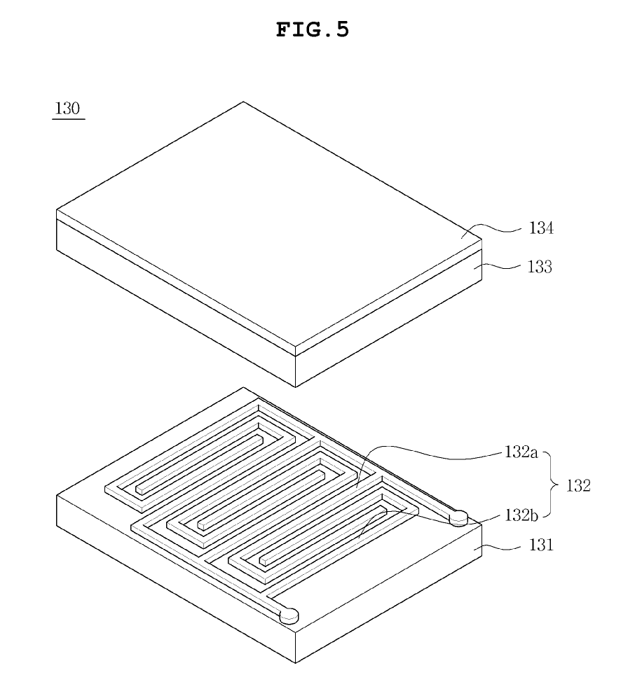

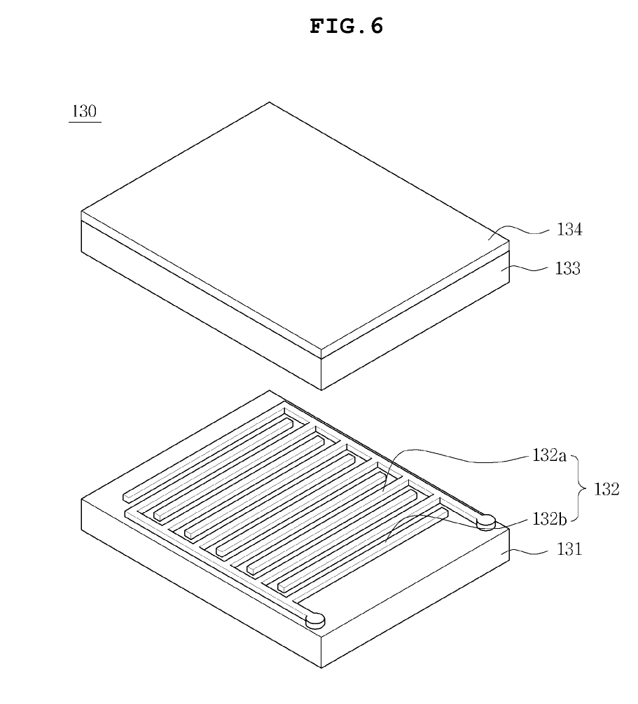

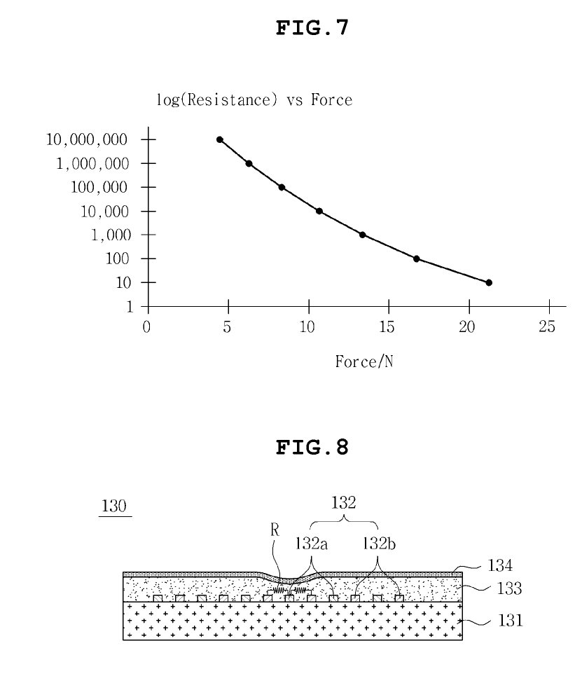

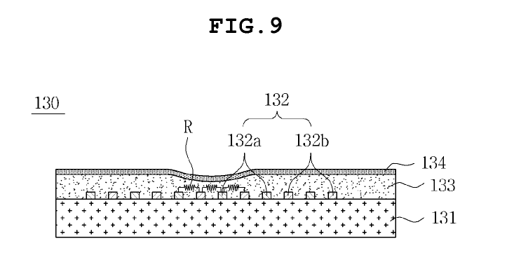

FIG. 2 is a cross-sectional view of a touch screen device 100 according to a preferred embodiment of the present invention, FIG. 3 is an exploded perspective view of the touch screen device 100 of FIG. 2, FIG. 4 is a cross-sectional view of a pressure-sensitive sensor 130 formed on the touch screen device 100 of FIG. 2, FIGS. 5 and 6 are exploded perspective views of the pressure-sensitive sensor 130 of FIG. 4, FIG. 7 is a graph showing change in resistance values depending on pressure applied to a quantum tunneling composite (QTC) that can be used as a piezo resistor 133 of the pressure-sensitive sensor 130 of FIG. 4, and FIGS. 8 and 9 are diagrams showing an operational method of the pressure-sensitive sensor 130 of FIG. 4. Hereinafter, the touch screen device 100 according to the present embodiment will be described with reference to these drawings.

As shown in FIGS. 2 and 3, the touch screen device 100 according to the present embodiment includes a touch panel 110, a display panel 120, and a pressure-sensitive sensor 130, wherein the pressure-sensitive sensor 130 includes a piezo resistor 133 of which resistance value is varied depending on pressure.

The touch panel 110 is a member that detects 2D coordinates of the contact input positions, that is, X-axis coordinates and Y-axis coordinates, and both resistive and capacitive touch screens may be used by way of example. Although a capacitive touch panel 110 having two opposite transparent substrates 111 is described by way of example, in the present embodiment, it should be understood that the present invention is not limited thereto and includes a configuration with which one transparent substrate 111 is provided, or the resistive touch screen.

Herein, the touch panel 110 may include two sheets of transparent substrates 111, transparent electrodes 112, electrode wirings 113, and a spacer 114.

The transparent substrate 111 is a member that provides a space where the transparent electrode 112 is formed, while protecting the touch panel 110.

Herein, the transparent substrate 111 is a part receiving an input from a specific object, such as the user's body or the stylus pen, etc., and preferably made of a material having large durability. Further, the transparent substrate 111 may be made of a transparent material for a user to be able to see an image from the display panel 120 well, and, for example, may be made of polyethylene terephthalate (PET) or glass.

Meanwhile, it is preferable to apply high-frequency treatment or primer treatment to one side of the transparent substrates 111 to improve the adhesion with the transparent electrodes 112.

The transparent electrode 112 is a member that is formed on one side of the transparent substrate 111 to sense signals from the contact input of a specific object.

Herein, the transparent electrode 112 senses change in capacitance from the contact input of a specific object, such as the user's body or a stylus pen, etc., and transfers the change to a controller (not shown). The controller (not shown) recognizes the coordinates of the pressed position, thereby implementing desired operations. More specifically, when high frequency is diffused throughout the transparent electrodes 112 by an applied voltage and then the contact input is applied by a human body etc., a predetermined change occurs in the capacitance while the transparent electrodes 112 function as electrodes and the transparent substrates 111 function as dielectrics, and the controller (not shown) can recognize the contact position or whether there is contact, by detecting the changed waveform.

Meanwhile, the transparent electrodes 112 are made of a transparent material for a user to be able to see the lower display panel 120 under them, and preferably have conductivity. For example, the transparent electrodes 112 may be made of conductive polymer containing poly-3,4-ethylenedioxythiophene/polystyrenesulfonate (PEDOT/PSS), polyaniline alone or a mixture thereof, or metal oxides, such as indium tin oxide (ITO). Further, the transparent electrode 112 may have various shapes, such as a rod shape, a diamond shape, a hexagonal shape, an octagonal shape, and a triangular shape.

The electrode wiring 113 is a member that is formed on the transparent substrate 111 to apply voltage to the transparent electrode 112.

Herein, the electrode wiring 113 may be made of a material having excellent electrical conductivity so as to supply voltage to the transparent electrode 112. For example, the electrode wiring 113 may be made of a material composed of silver (Ag) paste or organic silver. Further, the electrode wiring 113 may be made of a transparent material, such as a conductive polymer or a metal oxide, in order to reduce a bezel region, similar to the transparent electrode 112.

The spacer 114 insulates transparent electrodes 112 from each other, formed on the transparent substrates 111, respectively, while simultaneously bonding the two sheets of transparent substrates 111. Herein, although the material of the spacer 114 is not specifically limited, it is preferable to use an optical clear adhesive (OCA) having both insulation and adhesiveness.

The display panel 120, a member that displays images to a user, is bonded to one surface of the touch panel 110 by an adhesive layer 121.

Herein, the display panel 120 is an element displaying images for information transmission to the user and displaying reaction when the user touches the touch panel 110, to the user. The display panel 120 may be, for example, a liquid crystal display device (LCD), a plasma display panel (PDP), an electroluminescence (EL), a cathode ray tube (CRT) or the like.

Meanwhile, although the adhesive layer 121 is shown to be formed on only the outer sides between the touch panel 110 and the display panel 120 in FIG. 2, the present invention is not limited thereto but the adhesive layer 121 may be formed on the entire surface between the touch panel 110 and the display panel 120. At this time, when the adhesive layer 121 is formed on only the outer sides between the touch panel 110 and the display panel 120, for example, a double-sided adhesive tape (DAT) may be used, and when the adhesive layer 121 is formed on the entire surface between the touch panel 110 to and the display panel 120, for example, an optical clear adhesive (OCA) may be used.

The pressure-sensitive sensor 130 is a member that is impregnated into the adhesive layer 121 formed on the outer sides between the touch panel 110 and the display panel 120, wherein a plurality of pressure-sensitive sensors are spaced from each other. The pressure-sensitive sensor 130 is a member that senses the pressure of the contact input.

Herein, the pressure-sensitive sensors 130 may be constituted in a state in which the plurality of pressure-sensitive sensors are spaced from each other rather than be constituted to have a “ [symbol] ” shape surrounding the outer sides between the touch panel 110 and the display panel 120, as shown in FIG. 3. When the plurality of pressure-sensitive sensors 130 are spaced from each other, only the pressure-sensitive sensors 130 close to a region from which the contact input is generated operate, thereby making it possible to more accurately measure the strength of pressure as compared with the case in which the pressure-sensitive sensors 130 are constituted to have a “ [symbol] ” shape. Preferably, the pressure-sensitive sensors 130 may be formed on four sides and/or four apexes of the outer sides between the touch panel 110 and the display panel 120.

Meanwhile, the pressure-sensitive sensor 130 includes an insulating substrate 131, an electrode 132 configured to include an anode electrode 132a and a cathode electrode 132b, a piezo resistor 133, and an insulating layer 134, as shown in FIGS. 4 to 6. This will be described in detail.

The insulating substrate 131 is a base member that provides a space on which the electrode 132 is formed.

Herein, the insulating substrate 131 may, for example, be formed of a printed circuit board (PCB) to apply voltage to the electrode 132 and transfer the change in resistance or current sensed by the electrode 132 to the controller (not shown). Meanwhile, since the electrode 132 is formed on the upper surface of the insulating substrate 131 and the anode electrode 132a is not conducted with the cathode electrode 132b when there is no pressure, it is preferable that the upper surface of the insulating substrate 131 is made of an insulating material.

The electrode 132 is a member that includes the anode electrode 132a and the cathode electrode 132b and senses the change in resistance depending on the pressure.

Herein, the anode electrode 132a and the cathode electrode 132b may be spaced from each other to be intersected. For example, as shown in FIG. 5, the anode electrode 132a and the cathode electrode 132b each is constituted in a “ [symbol] ” shape in which that the same electrodes 132 are connected to each other and different electrodes 132 are intersected with each other. Alternatively, as shown in FIG. 6, the anode electrode 132a and the cathode electrode 132b each may be constituted in a rod shape, such that the same electrodes 132 are connected to each other and different electrodes 132 are intersected with each other. Meanwhile, the sensitivity of the pressure-sensitive sensor 130 can be controlled by controlling the intervals of the electrodes 132. This will be described below.

The piezo resistor 133, a member formed on the insulating substrate 131 on which the electrodes 132 are formed, is a member of which resistance is changed depending on the pressure to be applied.

Herein, it is preferable that the piezo resistor 133 is made of a material of which resistance becomes lower, depending on the applied pressure, so that the anode electrode 132a and the cathode electrode 132b can be mutually conducted. Further, it is preferable that the piezo resistor 133 is made of a material having elasticity so that the piezo resistor 133 can be returned to its original position when a contact input is released. As such a material, the piezo resistor 133 may, for example, include a quantum tunneling composite (QTC).

More specifically, as shown in FIG. 7, the piezo resistor 133 has a very large resistance value when there is no pressure from the contact input, such that although the anode electrode 132a and the cathode electrode 132b are in contact with the piezo resistor 133, current cannot flow current through the piezo resistor 133. On the other hand, when the contact input is applied to the touch panel 110 by the user's body or the like and the pressure is transferred to the pressure-sensitive sensor 130, the resistance value of the piezo resistor 133 is decreased, such that current can flow between the anode electrode 132a and the cathode electrode 132b. Further, as the pressure applied to the piezo resistor 133 becomes stronger, the resistance value of the piezo resistor 133 can be gradually decreased. Therefore, the current value that can be measured through the anode electrode 132a and the cathode electrode 132b can be increased and the resistance value can be decreased. Therefore, the strength of the contact input can be measured by measuring the current value flowing through the anode electrode 132a and the cathode electrode 132b or the resistance value between the anode electrode 132a and the cathode electrode 132b.

Meanwhile, as shown in FIGS. 8 and 9, as the pressure applied to the piezo resistor 133 becomes stronger, an area to which the pressure is applied is increased, such that the piezo resistor 133 having a larger area can be conducted. More specifically, although the pressure is applied to the piezo resistor 133, the resistance value of the piezo resistor 133 does not become 0, such that the piezo resistor 133 that can be conducted by the pressure will be represented by resistor R. For example, as shown in FIG. 8, when the area to which the pressure is applied is relatively small, one anode electrode 132a is connected to two cathode electrodes 132b, such that two resistors R may be connected in parallel. On the other hand, as shown in FIG. 9, when the area to which the pressure is applied is relatively large, two anode electrodes 132a are connected to two cathode electrodes 132b, such that three resistors R may be connected in parallel. Therefore, as described above, as the area to which the pressure is applied becomes larger, more resistors R are connected in parallel, such that the resistance value becomes smaller and thus the current value flowing between the anode electrode 132a and the cathode electrode 132b can be correspondingly increased.

Meanwhile, the intervals between the electrodes 132 may serve to control the sensitivity of the pressure-sensitive sensor 130. More specifically, when the interval between the anode electrode 132a and the cathode electrode 132b is wide, the change in the resistance value can be sensed only when the area to which the pressure is applied becomes larger, as compared to the case in which the interval therebetween is narrow. For example, when the interval between the anode electrode 132a and the cathode electrode 132b is wide, ‘an area to which the pressure is applied’ is required to be wider so as to increase one parallel resistor R. In contrast, when the interval between the electrodes 132 is narrow, the parallel resistor R can be increased even though ‘an area to which the pressure is applied’ is relatively slightly increased. Therefore, as described above, as the interval between the electrodes 132 is narrower, the strength of the contact input can be sensitively sensed even though the increase in the area is relatively small.

The insulating layer 134 is a member that is formed on the upper portion of the piezo resistor 133 to protect other constituents of the pressure-sensitive sensor 130.

Herein, the insulating layer 134 can prevent the current flowing on the piezo resistor 133 from flowing into other members of the touch panel 110, when the pressure is applied to the piezo resistor 133 so that the anode electrode 132a is conducted with the cathode electrode 132b through the piezo resistor 133. Therefore, the insulating layer 134 may be made of an insulating material, for example, an epoxy resin. Meanwhile, it is preferable that the insulating layer 134 is made of a material having elasticity so that the insulating layer 134 can be returned to its original position when the contact input is released, similar to the piezo resistor 133.

An operational principle of the touch screen device 100 will be described.

First, when a subject is input by contact, the transparent electrodes 112 of the touch panel 110 contact each other to grasp the positions of the contact input. Therefore, the X-axis coordinates and Y-axis coordinates of the contact input can be detected.

Next, when the pressure by the contact input of the subject is transferred to the pressure-sensitive sensor 130 through the touch panel 110, the pressure-sensitive sensor 130 can detect the strength of the contact input, that is, Z-axis coordinates. More specifically, the pressure reaching the pressure-sensitive sensor 130 is applied to the piezo resistor 133 and the resistance of the piezo resistor 133 is dropped, such that the anode electrode 132a is conducted with the cathode electrode 132b, thereby making it possible to measure the change in current or the resistance. At this time, as the pressure applied to the piezo resistor 133 and the area are larger, the resistance of the piezo resistor 133 is decreased, such that the current sensed by the electrodes 132 can be increased. Therefore, the electrodes 132 sense the strength of the contact input, thereby making it possible to detect the Z-axis coordinates.

Next, the display panel 120 can implement various interfaces as images based on the X-axis coordinates and Y-axis coordinates sensed by the touch panel 110 and the Z-axis coordinates sensed by the pressure-sensitive sensor 130.

According to the present invention, the touch screen device forms the pressure-sensitive sensors including the piezo resistors between the touch panel and the display panel, thereby making it possible to measure the pressure or the strength of the contact input.

In addition, according to the present invention, the plurality of pressure-sensitive sensors are installed to be spaced from each other, thereby making it possible to more accurately measure the pressure or the strength of the contact input.

In addition, according to the present invention, the insulating layer is formed on the upper portion of the piezo resistor, thereby making it possible to prevent a phenomenon that the electrodes of the pressure-sensitive sensors are short-circuit from the touch panel.

In addition, according to the present invention, the intervals between the electrodes formed on the pressure-sensitive sensor are changed, thereby making it possible to easily control the sensitivity of the pressure-sensitive sensors.

Although the preferred embodiments of the present invention have been disclosed for illustrative purposes, they are for specifically explaining the present invention and thus the touch screen device according to the present invention are not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A touch screen device, comprising:
a touch panel;
a display panel that is installed under the touch panel; and
a plurality of pressure-sensitive sensors that are formed to be spaced from each other on the outer sides between the touch panel and the display panel and include an insulating substrate, electrodes that include anode electrodes and cathode electrodes formed to be spaced from each other on the insulating substrate, and piezo resistors that are formed on the insulating substrate on which the electrodes are formed and have resistance values varied depending on the pressure to be applied.

2. The touch screen device as set forth in claim 1, wherein the pressure-sensitive sensor further includes an insulating layer formed on the piezo resistor.

3. The touch screen device as set forth in claim 1, wherein the piezo resistor has a resistance value decreased when pressure is applied.

4. The touch screen device as set forth in claim 1, wherein the resistance value of the piezo resistor is decreased when the pressure is applied to the pressure-sensitive sensor so that the anode electrode is conducted with the cathode electrode through the piezo resistor.

5. The touch screen device as set forth in claim 1, wherein the pressure-sensitive sensor is formed at four sides, four apexes, or them of the outer sides between the touch panel and the display panel.

6. The touch screen device as set forth in claim 1, wherein the piezo resistor includes a quantum tunneling composite (QTC).

7. The touch screen device as set forth in claim 1, wherein the touch panel is a resistive type or a capacitive type.
